(19) United States
(12) Patent Application Publication
(10) Pub. No.: US 2004/0039181 A1
(43) Pub. Date: Feb. 26, 2004

(54) Process for preparing aromatic azo and hydrazo compounds, aromatic amides and aromatic amines

(76) Inventors: Roger Keranen Rains, Richfield, OH (US); Donald L. Fields JR., Copley, OH (US); Ralph Dale Triplett II, Wadsworth, OH (US)

Correspondence Address: LOUIS A. MORRIS, AKZO NOBEL INC., 7 LIVINGSTONE AVENUE, DOBBS FERRY, NY, 10522-3408, US

(21) Appl. No.: 10/442,012

(22) Filed: May 20, 2003

Related U.S. Application Data
(60) Provisional application No. 60/399,089, filed on Jul. 29, 2002.

(51) Int. Cl. C09B 62/006; C09B 62/58

(52) U.S. Cl. 534/588; 534/590

(57) ABSTRACT

A process for producing amino or amido substituted aromatic azo or hydrazo compounds, or aminoaromatic amines, or aminoaromatic amides, or mixtures thereof, comprises the steps of:

(a) bringing into reactive contact in a suitable solvent system a nucleophilic compound selected from the group of aniline, substituted aniline derivatives, aliphatic amines, substituted aliphatic amine derivatives, amides and substituted amide derivatives with an azo containing compound; and

(b) reacting the nucleophilic compound and the azo containing compound in a confined zone at a suitable time, pressure and temperature.

### CROSS REFERENCE TO RELATED APPLICATION

This application claims priority of Provisional Application No. 60/399,089, filed Jul. 29, 2002.

### BACKGROUND OF THE INVENTION

1. Field of the Invention

This invention relates to the production of aromatic azo and hydrazo compounds, aromatic amides and aromatic amines.

2. Prior Art

U.S. Pat. No. 5,117,063 discloses processes for preparing 4-nitrodiphenylamine and 4-nitrosodiphenylamine, by reaction of aniline or substituted derivatives thereof with nitrobenzene or substituted derivatives thereof, under aerobic and anaerobic conditions, in the presence of various bases, including an inorganic base with crown ether as a phase transfer catalyst.

U.S. Pat. No. 5,233,010; U.S. Pat. No. 5,382,691; U.S. Pat. No. 5,451,702; U.S. Pat. No. 5,552,531; U.S. Pat. No. 5,618,979; U.S. Pat. No. 5,633,407 and WO 93/24450 disclose processes for preparing substituted aromatic azo compounds and aromatic amines by reaction of an aromatic amine, or aliphatic amine or amide with an azo containing compound, under aerobic and anaerobic conditions. The use of various bases is disclosed and crown ethers are used as a phase transfer catalyst in conjunction with an inorganic base or a metal organic base. When tetramethylammonium hydroxide is used alone as base under conditions of azeotropic removal of water and aniline, 6% methyl aniline is reported, which is indicative of significant decomposition of the base. U.S. Pat. No. 5,382,691 describes the use of various alcohols for reducing azo compounds to the corresponding amines. Aminolysis and hydrolysis of amides to amines is also discussed.

WO 95/09148 discloses processes for aromatic azo compounds and aromatic amines by reaction of aniline or substituted derivative thereof with an azo compound in the presence of an inorganic or metal organic base (potassium t-butoxide in all examples) and various solvents, primarily various glycolic ether compounds (glimes), under anaerobic conditions, including an atmosphere of hydrogen.

Stern, Michael K. et al., A New Route to 4-Aminodiphenylamine via Nucleophilic Aromatic Substitution for Hydrogen: Reaction of Aniline and Azobenzene, J. Org. Chem., 59, 5627-5632 (1994) discloses the chemistry and reaction mechanisms involved with coupling of aniline with azobenzene in the presence of a strong base. The use of a crown ether as a phase transfer catalyst with potassium t-butoxide is included. The paper reports that hydrogen peroxide is made in situ at aerobic conditions from reaction of oxygen with hydrazobenzene. However, the peroxide is reported to decompose with formation of oxygen and water rather than react directly as an oxidant.

Moskalev, N. V., One-pot oxidative transformation of aniline into 4-phenylazodiphenylamine in the DMSO-KOH system, Mendeleev Communications, p. 114 (1996) discloses that aniline is reacted in the presence of DMSO, powdered KOH and oxygen to 4-phenylazodiphenylamine (PADPA). The author surmises that aniline is first oxidized to azobenzene, which in turn reacts with excess aniline to afford PADPA. PADPA was not formed when ethanol, 1,4-dioxane, or DMF was used as the solvent. Also, ortho-and para-toluidines showed no reactivity, whereas meta-toluidine gave the methyl substituted product corresponding to PADPA.

Stern, M. K., B. K. Cheng and J. Clark, Eliminating chlorine in the synthesis of aromatic amines: new routes which utilize nucleophilic aromatic substitution for hydrogen, New J. Chem., 20(2), 259-268, 1996, discusses the amination of azobenzene via the reaction of aniline with azobenzene in the presence of a strong base, such as potassium t-butoxide/19-crown-6 or tetramethylammonium hydroxide, to make amino substituted azobenzenes. Use of aerobic conditions to oxidize hydrazo compounds to the corresponding azo compounds is discussed. In situ formation of hydrogen peroxide from the oxidation reaction is also discussed. The peroxide is presumed to decompose to oxygen and water rather than react directly as an oxidant.

U.S. Pat. No. 5,331,099, WO 93/24447 and U.S. Pat. No. 5,233,010 disclose the preparation of nitroaromatic amides and the corresponding amines produced therefrom, by reaction of an amide with nitrobenzene in the presence of a suitable base and solvent and a controlled amount of protic material. Coverage is for amides with at least one —NH₂ group, and includes urea. Examples illustrate the reaction of benzamide with nitrobenzene to make substituted amides. The use of 18-crown-6 and tetrabutylammonium chloride as phase transfer catalysts with KOH and potassium t-butoxide is illustrated for anaerobic conditions. It is further disclosed that in general, use of aerobic conditions reduces the formation of azoxybenzene. Aminolysis and hydrolysis of amides to amines is also discussed.

It is an object of the invention to provide a process for producing aromatic amines or substituted derivatives thereof, for use in preparing alkylated aromatic diamines or substituted derivatives thereof. It is a further object of the invention to provide a process for producing p-phenylenediamines or substituted derivatives thereof, including 4-aminodiphenylamine (4-ADPA) or substituted derivatives thereof or p-phenylenediamine (p-PDA) or substituted derivatives thereof, for use in preparing alkylated p-phenylenediamines or substituted derivatives thereof. It is a still further object of the invention to provide efficient and economical processes for producing 4-ADPA and p-PDA or substituted derivatives thereof and alkylated p-phenylenediamines that are commercially viable. It is an even further object of the invention to provide a process for producing alkylated p-phenylenediamines or substituted derivatives thereof for use as antioxidants and antiozonants. It is a further object of the invention to provide a process for producing p-aminoaromatic amides for use as monomers in the production of polyamides or other polymer applications. It is a still further object of the invention to provide a process for producing aminocycloaliphatic amines for use as intermediates to isocyanates useful in coatings and to make thermoplastic elastomers.

### SUMMARY OF THE INVENTION

Accordingly, this invention relates to the production of amido substituted aromatic azo and aromatic hydrazo compounds, amino substituted aromatic azo and aromatic hydrazo compounds, amino substituted aromatic amides, aminoaromatic amines, monoalkylated aromatic diamines, dialkylated aromatic diamines, arylamino aromatic diamines, alkyl-aryl aromatic diamines and alkylamino substituted aromatic amides, wherein “amido substituted” and “amino substituted” for aromatic azo and hydrazo compounds include “diamido substituted” and “diamino substituted”, and “amino” and amido” can include substituted amines and amides. In another aspect, this invention relates to the preparation of 4-ADPA or substituted derivatives thereof. In another aspect, this invention relates to the preparation of p-PDA or substituted derivatives thereof. In yet another aspect, this invention relates to the preparation of monoalkylated and dialkylated aromatic diamines or substituted derivatives thereof, useful as antioxidants, such as alkylated 4-ADPA or dialkylated p-PDA or substituted derivatives thereof.

One embodiment of the invention comprises a process for producing amino or amido substituted aromatic azo or hydrazo compounds, or aminoaromatic amines, or aminoaromatic amides, or mixtures thereof, comprising the steps of:

(a) bringing into reactive contact in a suitable solvent system a nucleophilic compound selected from the group consisting of aniline, substituted aniline derivatives, aliphatic amines, substituted aliphatic amine derivatives, amides and substituted amide derivatives; and

(b) reacting the nucleophilic compound and an azo containing compound in a confined zone at a suitable time, pressure and temperature, in the presence of a mixture comprising a strong base and one or more of a phase transfer catalyst selected from the group of compounds defined by:

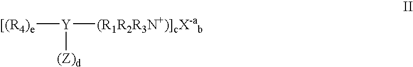

where R₁, R₂, R₃ are the same or different and selected from any straight chain or branched alkyl group containing from C₁ to C₂₀, (R₄)ₑ is hydrogen for e=0, (R₄)ₑ is R₁R₂R₃N⁺for e=1, 2 or 3, Y is alkyl, aryl, alkyl aryl or benzyl and substituted derivatives thereof, Z is a substituent selected from the group consisting of hydroxyl, halo, and other hetero atoms, X is an anionic moiety of the form fluoride, chloride, bromide, hydroxide, sulfate, hydrogensulfate, acetate, formate, nitrate, phosphate, hydrogen phosphate, dihydrogen phosphate, oxalate, carbonate, bicarbonate, borate, hydrogen borate, dihydrogen borate, silicate, hydrogen silicate, dihydrogen silicate, trihydrogen silicate, cyanide, sulfide, phenolic, tartrate, citrate, malonate and mixtures of said compounds, where a=the valence of the anionic moiety (1, 2, 3 or 4), b and c are whole number integers of value 1, 2, 3 or 4 and d is a whole number integer of value 0 to 4.

A second embodiment of the invention comprises a process for producing amino or amido substituted aromatic azo or hydrazo compounds, or aminoaromatic amines, or aminoaromatic amides, or mixtures thereof, comprising the steps of:

(a) bringing into reactive contact in a suitable solvent system a nucleophilic compound selected from the group consisting of aniline, substituted aniline derivatives, aliphatic amines, substituted aliphatic amine derivatives, amides and substituted amide derivatives with an azo containing compound; and

(b) reacting the nucleophilic compound and an azo containing compound in a confined zone at a suitable time, pressure and temperature, in the presence of a mixture comprising an inorganic salt or metal organic salt, or mixture thereof, having a cation that would be a suitable cation of a strong inorganic base and one or more of an organic base selected from the group of compounds defined by:

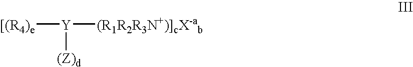

where R₁, R₂, R₃ are the same or different and selected from any straight chain or branched alkyl group containing from C₁ to C20, (R₄)ₑ is hydrogen for e=0, (R₄)ₑ is R₁R₂R₃N⁺ for e=1, 2, or 3, X is an anion capable of abstracting a proton from the nitrogen of an aniline or aniline derivative, Y is alkyl, aryl, alkyl aryl or benzyl and substituted derivatives thereof, Z is a substituent selected from the group consisting of hydroxyl, halo, and other hetero atoms, where a=the valence of the anionic moiety (1, 2, 3 or 4), b and c are whole number integers of value 1, 2, 3 or 4 and d is a whole number integer of value 0 to 4.

A third embodiment of the invention comprises a process for producing amino or amido substituted aromatic azo or hydrazo compounds, or aminoaromatic amines, or aminoaromatic amides, or mixtures thereof, comprising the steps of:

(a) bringing into reactive contact in a suitable solvent system a nucleophilic compound selected from the group of aniline, substituted aniline derivatives, aliphatic amines, substituted aliphatic amine derivatives, amides and substituted amide derivatives with an azo containing compound; and

(b) reacting the nucleophilic compound and the azo containing compound in a confined zone at a suitable time, pressure and temperature, in the presence of a mixture comprising an oxidant and a strong base that also functions as a phase transfer catalyst selected from the group of compounds defined by:

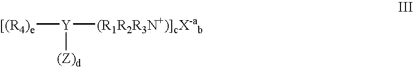

where R₁, R₂, R₃ are the same or different and selected from any straight chain or branched alkyl group containing from C₁ to C₂₀, (R₄)ₑ is hydrogen for e=0, (R₄)ₑ is R₁R₂R₃N⁺ for e=1, 2, or 3, X is an anion capable of abstracting a proton from the nitrogen of an aniline or aniline derivative, Y is alkyl, aryl, alkyl aryl or benzyl and substituted derivatives thereof, Z is a substituent selected from the group consisting of hydroxyl, halo, and other hetero atoms, where a=the valence of the anionic moiety (1, 2, 3 or 4), b and c are whole number integers of value 1, 2, 3 or 4 and d is a whole number integer of value 0 to 4.

In a fourth embodiment, the invention comprises a process for directly producing amino substituted aromatic azo compounds, or hydrazo compounds, or aminoaromatic amines, or mixtures thereof by reacting a urea or an amide with an azo containing compound.

Other embodiments of the present invention encompass details about suitable substituted and unsubstituted amines and amides, reaction mixtures, ratios of ingredients, particular phase transfer catalysts and particular strong bases for the first embodiment above, particular inorganic salts and particular organic bases for the second and third embodiments above, all of which are hereinafter disclosed in the following discussion of each of the facets of the present invention. The reactions may be conducted under oxidative or non-oxidative conditions, as discussed in the text below. Oxidative conditions permit the use of hydrazo compounds as the azo containing compound described in the first embodiment, as the corresponding azo compound is generated in situ. Moreover, the use of azoxy compounds as the azo containing compound produces substituted azo compounds directly. Furthermore, substituted hydrazo compounds produced according to the invention can, under appropriate conditions, such as elevated temperature, disproportionate to the corresponding amines. In the ensuing discussion, reference to amides and amines, other than to specific compounds, is meant to include substituted derivatives thereof and the term amide is meant to include thioamide. Moreover, amino (or amido) can include arylamino (or arylamido) and alkylamino (or alkylamido), when used alone or in combination, such as aminoaromatic (or amidoaromatic), and amino (or amido) substituted azo (or hydrazo) can include diamino (or diamido) substituted azo (or hydrazo).

### BRIEF DESCRIPTION OF THE DRAWING

FIG. 1 comprises a graphical representation of reaction profiles associated with Example 9.

### DETAILED DESCRIPTION OF THE INVENTION

The methods of the first three embodiments of the invention, as described above, are for making substituted aromatic azo and hydrazo compounds, aromatic amines and aromatic amides. The three methods respectively describe reaction in the presence of a strong base with a phase transfer catalyst, an inorganic salt and/or metal organic salt with an organic base, each with or without an added oxidant, and reaction in the presence of a strong base that can also function as a phase transfer catalyst, in the presence of an added oxidant. It is further directed to methods of converting amido compounds to the corresponding amino compounds, by aminolysis or hydrolysis. It is further directed to making intermediates for 4-aminodiphenylamine (4-ADPA) and p-phenylenediamine (p-PDA) and substituted derivatives thereof. The intermediates may then be reacted to produce 4-ADPA or p-PDA or substituted derivatives thereof. It is further directed to methods for reductive alkylation of intermediates for 4-ADPA and p-PDA, or of 4-ADPA and p-PDA or of substituted derivatives thereof to produce alkylated 4-ADPA or dialkylated p-PDA or substituted derivatives thereof. It is further directed to reduction of alkylamino azo and hydrazo compounds or substituted derivatives thereof to produce alkylamino aromatic diamines. It is also directed to a method for preparation of alkylamino aromatic amides.

The azo containing compounds that may be employed in the invention are represented by the formula:

X—R₁—N═N—R₂—Y I

including azoxy or hydrazo derivatives thereof, wherein R₁ is an aromatic group and R₂ is selected from the group consisting of aliphatic and aromatic groups and X and Y are independently selected from the group consisting of hydrogen, halides, —NO₂, —NH₂, aryl groups, alkyl groups, alkoxy groups, sulfonate groups, —SO₃H, —OH, —COH, —COOH, and alkyl, aryl, alkylaryl or benzyl groups, containing at least one —NH₂ group, wherein if R₂ is aliphatic, X is in the meta or ortho position on R₁, and if R₂ is aromatic, at least one of X and Y is on the meta or ortho position on R₁ and R₂ respectively, and wherein halides are selected from the group consisting of fluoride, chloride, and bromide.

According to the process of the invention, when both R₁ and R₂ of formula I are aromatic and both para positions are unsubstituted, then both R₁ and R₂ can be substituted by the nucleophile as described in (b) of the first three embodiments to produce diamido or diamino substituted aromatic azo and/or hydrazo compounds.

Suitable amides for use in the invention include thioamide and suitable aliphatic amines include aralkyl amine.

The amido substituted aromatic azo and/or hydrazo compounds or substituted derivatives thereof, prepared by reacting a urea or an amide with an azo containing compound according to the invention, may be unstable under reaction conditions. The invention thus provides for direct preparation of amino substituted aromatic azo and/or hydrazo compounds and/or aminoaromatic amines.

With regard to the three primary embodiments of the invention described above, reaction results for yield and selectivity should be equivalent with equivalent pairs of components, such as tetramethylammonium chloride with KOH vs. tetramethylammonium hydroxide with KCl. Phase transfer catalysts are defined by formula II above, while organic bases and strong base/phase transfer catalysts are defined by formula III above. One skilled in the art can determine which of the organic bases defined by formula III can be suitable for the third embodiment of the process of the invention as organic bases that also function as phase transfer catalysts.

Amino substituted aromatic azo and hydrazo compounds or substituted derivatives thereof, may be prepared by reacting amido substituted aromatic azo and/or hydrazo compounds, prepared by reacting an amide with an azo containing compound in accordance with the methods of the invention with a nucleophile to produce the corresponding amide and the amino substituted aromatic azo and/or hydrazo compound. The preferred nucleophiles are ammonia and aniline.

The amido substituted aromatic azo and/or hydrazo compounds may be reacted with water in the presence of a suitable basic or acidic catalyst to produce the acid or salt thereof corresponding to the amide starting material and the amino substituted aromatic azo and/or hydrazo compound.

Aminoaromatic amides or substituted derivatives thereof may be prepared by reducing the amido substituted aromatic azo and/or hydrazo compounds, prepared in accordance with methods of the invention alone or in mixtures with aminoaromatic amides.

Alkylamino aromatic amides may be prepared by reductively alkylating the aminoaromatic amides, or the amido substituted aromatic azo and/or hydrazo compounds, or mixtures thereof that are prepared according to methods of the invention.

Aminoaromatic amines or substituted derivatives thereof may be prepared by reacting the aminoaromatic amide or substituted derivatives thereof prepared in accordance claim 1 with a nucleophile or water to produce the respective amide, or the acid or salt thereof corresponding to the amide starting material, and the aminoaromatic amine.

Aminoaromatic amines or substituted derivatives thereof may be prepared by reducing the amino substituted aromatic azo and/or hydrazo compounds, alone or in mixtures with aminoaromatic amines, which are prepared according to methods of the invention.

Monoalkyl aromatic diamines or substituted derivatives thereof may be prepared by reducing the alkylamino substituted or di(alkylamino) substituted azo and/or hydrazo compounds or substituted derivatives thereof, prepared by the reaction of an aliphatic amine or substituted derivatives thereof with an azo compound or substituted derivatives thereof in accordance with methods of the invention. The monoalkyl aromatic diamines may be reductively alkylated to produce dialkylated aromatic diamines.

Arylamino aromatic diamines or substituted derivatives thereof may be prepared by reducing the arylamino substituted or di(arylamino) substituted azo and/or hydrazo compounds or substituted derivatives thereof, prepared by the reaction of an aromatic amine or substituted derivatives thereof with an azo compound or substituted derivatives thereof in accordance with methods of the invention. The arylamino aromatic diamines may be reductively alkylated to prepare alkylated arylamino aromatic diamines.

Alkylated arylamino aromatic diamines and dialkylated phenylenediamines or substituted derivatives thereof, may be prepared by reductively alkylating the amino, arylamino or alkylamino substituted aromatic azo and/or hydrazo compounds, or aminoaromatic amines, or mixtures thereof that are prepared in accordance with methods of the invention.

4-aminodiphenylamine may be prepared by reducing the phenylamino substituted aromatic azo and/or hydrazo compounds, alone or in mixtures with 4-aminodiphenylamines, which are prepared according to methods of the invention, wherein the azo containing compound is azobenzene and the nucleophilic compound is aniline, formanilide, phenylurea, carbanilide, thiocarbanilide, or mixtures thereof.

P-phenylenediamine may be prepared by reducing the amino substituted aromatic azo and/or hydrazo compounds, alone or in mixtures with p-phenylenediamine, which are prepared according to methods of the invention, wherein the azo containing compound is azobenzene and the nucleophilic compound is urea.

Aminoaromatic amines, alkylamino aromatic diamines or arylamino aromatic diamines, or substituted derivatives thereof may be prepared by reducing, in the presence of water and an acidic or basic catalyst, the amido substituted aromatic azo and/or hydrazo compounds, alone or in mixtures with the corresponding aminoaromatic amines, which are prepared according to methods of the invention, to produce the amine compound and the acid or salt thereof corresponding to the starting amide.

Aminoaromatic amines, alkylamino aromatic diamines or arylamino aromatic diamines, or substituted derivatives thereof may be prepared by reducing, in the presence of a nucleophile, the amido substituted aromatic azo and/or hydrazo compounds, alone or in mixtures with the corresponding aminoaromatic amines, which are prepared according to the methods of the invention, to produce the amine compound and the corresponding amide. The preferred nucleophiles are ammonia and aniline.

Aminoaromatic amines, alkylamino aromatic diamines or arylamino aromatic diamines, or substituted derivatives thereof may be prepared by reducing, in the presence of water and a suitable basic or acidic catalyst, the amido substituted aromatic azo and/or hydrazo compounds, alone or in mixtures with the corresponding aminoaromatic amines, which are prepared according to the methods of the invention, to produce the amine compound and the acid or salt thereof corresponding to the starting amide.

Alkylated arylamino aromatic diamines and dialkylated aromatic diamines, or substituted derivatives thereof may be prepared by reductively alkylating, in the presence of water and a suitable basic or acidic catalyst, the amido substituted aromatic amine compounds, which are prepared according to the methods of the invention, to produce the alkylated amine compound and the acid or salt thereof corresponding to the starting amide.

Alkylated arylamino aromatic diamines and dialkylated aromatic diamines, or substituted derivatives thereof may be prepared by reductively alkylating, in the presence of water and a suitable basic or acidic catalyst, the amido substituted aromatic azo and/or hydrazo compounds, alone or in mixtures with the corresponding aminoaromatic amines, which are prepared according to the methods of the invention, to produce the alkylated amine compound and the acid or salt thereof corresponding to the starting amide.

An example of a substituted and multifunctional phase transfer catalyst that is consistent with the above formula II is (2S,3S)-bis(trimethylammonio)-1,4-butanediol dichloride. Other effective phase transfer catalysts fitting formula II can be derived from the literature, such as C. M. Starks and C. Liotta, Phase Transfer Catalysis, Principles and Techniques, Academic Press, 1978 and W. E. Keller, Fluka-Compendium, Vol. 1,2,3, Georg Thieme Verlag, New York, 1986, 1987, 1992.

An example of a substituted and multifunctional organic base that is consistent with the above formula III is (2S,3S)-bis(trimethylammonio)-1,4-butanediol dihydroxide. Other effective organic bases fitting formula III can be derived from the above phase transfer catalysts, wherein the anion is replaced by hydroxide or other suitable anion.

Phase transfer catalysts believed to be particularly effective in the method of the invention include, but are not limited to, tetramethylammonium chloride, tetramethylammonium fluoride, tetramethylammonium hydroxide, bis-tetramethylammonium carbonate, tetramethylammonium formate and tetramethylammonium acetate; tetrabutylammonium hydrogensulfate and tetrabutylammonium sulfate; methyltributylammonium chloride; and benzyltrimethylammonium hydroxide (Triton B), tricaprylmethylammonium chloride (Aliquat 336), tetrabutylammonium chloride, tetramethylammonium nitrate, cetyltrimethylammonium chloride and choline hydroxide.

Phase transfer catalysts of the present invention have several advantages over crown ethers, such as 18-crown-6, which were described as effective with alkali metal hydroxides and alkali metal alkoxides in U.S. Pat. No. 5,451,702 and related patents cited herein. The most obvious disadvantages of crown ethers are very high initial cost and high toxicity. In addition, most crown ethers have poor solubility in water, so they cannot be recovered for recycle with an aqueous base stream. Furthermore, the boiling points of crown ethers are high enough that they cannot be recovered by distillation without an extra distillation step. Even for the class of crown ethers that have good solubility in water, solubility in organics is also good, so that there will be a high loss to the organic product stream. Finally, crown ethers are known chelating agents, so that there is a high probability of unacceptable loss of expensive hydrogenation catalyst metal, due to complexation with the crown ether.

In the method of the invention, the molar ratio of phase transfer catalyst to azo containing compound reactant is preferably from about 0.05:1 to about 2:1.

Organic bases believed to be particularly effective for the second and third embodiments of the method of the invention include quaternary ammonium hydroxides selected from the group consisting of, but not limited to, tetramethylammonium hydroxide, tetrabutylammonium hydroxide, methyltributylammonium hydroxide, benzyltrimethylammonium hydroxide (Triton B), tricaprylmethylammonium hydroxide, cetyltrimethylammonium hydroxide and choline hydroxide, and equivalent quaternary ammonium alkoxides, acetates, carbonates, bicarbonates, cyanides, phenolics, phosphates, hydrogen phosphates, hypochlorites, borates, hydrogen borates, dihydrogen borates, sulfides, silicates, hydrogen silicates, dihydrogen silicates and trihydrogen silicates.

With respect to step (b) of the first three embodiments, the terms “strong base” as used in conjunction with a phase transfer catalyst and “strong inorganic base” as used with respect to the meaning of a cation of an inorganic salt or metal organic salt, are intended to mean a base that is capable of abstracting a proton from the nitrogen of aniline or an aniline derivative and may include any base having a pK_{b} less than about 9.4, which is the pK_{b} of aniline. Various aniline derivatives may have different pK_{b} values, but a pK_{b} of about 9.4 is employed as a general guide. The base will preferably have a pK_{b} less than about 7.4.

The term “capable of abstracting a proton from the nitrogen of aniline or an aniline derivative” as applied to anion “X” of formula II, is intended to mean an anion also having a pK_{b} value as discussed above with respect to the strong inorganic base.

Possible anions for “X” in formula III, in addition to hydroxide, include, but are not limited to: alkoxide (pK_{b}<1), acetate (pK_{b}=9.25), carbonate (pK_{b}=3.75), bicarbonate (pK_{b}=7.6), cyanide (pK_{b}=4.7), phenolic (pK_{b}=4.1), phosphate (pK_{b}=1.3), hydrogen phosphate (pK_{b}=6.8), hypochlorite (pK_{b}=6.5), borate (pK_{b}<1), hydrogen borate (pK_{b}<1), dihydrogen borate (pK_{b}=4.7), sulfide (pK_{b}=1.1), silicate (pK_{b}=2), hydrogen silicate (pK_{b}=2), dihydrogen silicate (pK_{b}=2.2) and trihydrogen silicate (pK_{b}=4.1).

Suitable nucleophiles for the first three embodiments are aniline, substituted anilines, aliphatic amines, substituted aliphatic amines, amides and substituted amides as defined in U.S. Pat. No. 5,233,010; U.S. Pat. No. 5,382,691; U.S. Pat. No. 5,451,702; U.S. Pat. No. 5,552,531; U.S. Pat. No. 5,618,979 and U.S. Pat. No. 5,633,407, all incorporated by reference herein, and in any event, the list of amides includes urea, benzamide, formanilide, phenylurea, carbanilide, thiocarbanilide and other thioamides equivalent to the suitable amides. Suitable nucleophiles for the fourth embodiment are any amide that produces amido and/or diamido substituted azo and/or hydrazo compounds that, depending on reaction conditions, can be unstable, such that the corresponding amino and/or diamino substituted azo and/or hydrazo compounds are formed directly. One skilled in the art can determine which of the amides cited above will be suitable for the fourth embodiment. Examples of suitable starting amides are formanilide, phenylurea, carbanilide, thiocarbanilide and urea. The first four can directly give arylamino and/or di(arylamino) substituted aromatic azo and/or hydrazo compounds and/or arylamino aromatic diamines; urea can directly give amino and/or diamino substituted aromatic azo and/or hydrazo compounds and/or phenylenediamines; and suitable N-(alkyl)amides can directly give alkylamino and/or di(alkylamino) substituted aromatic azo and/or hydrazo compounds and/or alkylamino aromatic diamines.

Although the reactants of the method of the invention may be referred to as “aniline” and “azobenzene”, and when it is 4-ADPA that is being manufactured the reactants can in fact be aniline and azobenzene, it is understood that the reactants may also comprise substituted aniline or aniline derivatives and substituted azobenzene. Typical examples of substituted anilines that may be used in accordance with the process of the present invention, in addition to aniline, include but are not limited to, 2-methoxyaniline, 4-methoxyaniline, 4-chloroaniline, p-toluidine, o-toluidine, m-toluidine, 4-nitroaniline, 3-bromoaniline, 3-bromo-4-aminotoluene, p-aminobenzoic acid, 2,4-diaminotoluene, 2,5-dichloroaniline, 1,4-phenylenediamine, 4,4′-methylene dianiline, 1,3,5-triaminobenzene, and mixtures thereof. Examples of azo containing compounds include, but are not limited to, azobenzene, substituted azobenzene derivatives, such as p-aminoazobenzene, azoxybenzene, 1,2-diphenylhydrazine, 4-(phenylazo)diphenylamine and mixtures thereof. Other typical examples of substituted azobenzenes are described in U.S. Pat. No. 5,451,702 and related patents cited above.

When the nucleophilic compound used to react with azobenzene is aniline and the reaction is conducted under oxidative conditions, azobenzene can be produced in situ via the oxidative coupling of aniline in the presence of a suitable base. See U.S. Pat. No. 5,451,702 and related patents cited above for further discussion. Various substituted anilines, which can be determined by one skilled in the art, can similarly form the corresponding substituted azobenzene compounds by in situ oxidative coupling.

Suitable aniline derivatives for producing 4-ADPA or substituted derivatives thereof include, but are not limited to, aniline, substituted anilines and amides such as formanilide, phenylurea, carbanilide and thiocarbanilide. Other suitable aniline derivatives can be selected from those that are disclosed in the references cited above.

Furthermore, although the amide of the method of the invention may be referred to as “benzamide or urea”, and when it is p-PDA that is being manufactured the amide may in fact be benzamide or urea, it is understood that any amide with a —NH₂ group, other than a N-substituted urea, or substituted derivatives thereof can be suitable for producing p-PDA. Examples of suitable aromatic amides and substituted aromatic amide derivatives include, but are not limited to, benzamide, 4-methylbenzamide, 4-methoxybenzamide, 4-chlorobenzamide, 2-methylbenzamide, 4-nitrobenzamide, 4-aminobenzamide and mixtures thereof. Examples of suitable aliphatic amides and substituted aliphatic amide derivatives include, but are not limited to, isobutyramide, urea, acetamide, propylamide and mixtures thereof. Examples of suitable diamides include, but are not limited to, adipamide, oxalic amide, terephthalic diamide, 4,4′-biphenyldicarboxamide and mixtures thereof. Other suitable amides can be selected from those that are disclosed in the references cited above.

The method of the invention will hereinafter be described with reference to the manufacture of 4-ADPA itself, starting from aniline and azobenzene and p-PDA itself, starting from benzamide or urea and azobenzene.

The molar ratio of aniline or benzamide to azobenzene in the process according to the present invention is not particularly important, as the process will be effective with an excess of either. It is generally accepted that having an excess of one primary reactant over the other increases reaction yield and rate. Accordingly, a mole ratio range of about 0.1/1 to 10/1 for aniline/azobenzene and benzamide/azobenzene is expected to be particularly effective for the process of the invention. However, when a primary amine is produced directly, such as with urea, or when the substituted hydrazo compound disproportionates to the corresponding amines, it is possible for the amines so formed to react with the starting azo containing compound. So in these cases, the best results are obtained with an excess of the starting nucleophile and an effective mole ratio range of about 1.05/1 to 10/1 for aniline/azobenzene and urea/azobenzene would apply.

Strong bases believed to be particularly effective with a phase transfer catalyst in the first embodiment of the process of the invention include potassium hydroxide, sodium hydroxide, cesium hydroxide, rubidium hydroxide and potassium-t-butoxide. It is preferred that mole ratio of strong base to azobenzene is greater than about 1:1. A particularly preferred mole ratio of strong base to azobenzene is about 2:1 to about 6:1.

Inorganic salts and metal organic salts that may be used in conjunction with an organic base in the second embodiment of the process of the invention have a cation that would be a suitable cation of a strong inorganic base. These inorganic salts and metal organic salts are selected from the group consisting of, but not limited to, the fluoride, chloride, bromide, sulfate, hydrogen sulfate, nitrate, phosphate, dihydrogen phosphate, formate, acetate, oxalate, malonate, citrate, tartrate, maleate, chlorate, perchlorate, chromate, rhenate and carbonate salts of cesium, rubidium, potassium and sodium. In the method of the invention, the inorganic salt or metal organic salt may be used in molar ratio to azobenzene from about 0.05:1 to about 6.5:1.

Inorganic salts and metal organic salts believed to be particularly effective in the second embodiment of the process of the present invention are those that afford acceptable solubility for the inorganic salt or metal organic salt-organic base combination in the reaction medium, including the fluoride, chloride, bromide, sulfate, hydrogen sulfate, nitrate, phosphate, formate, acetate and carbonate salts of cesium, rubidium, potassium and sodium and mixtures thereof. It is preferred that the mole ratio of organic base used with an inorganic salt or metal organic salt to azobenzene is greater than or equal to about 1:1. It is also preferred that the mole ratio of inorganic salt or metal organic salt to organic base is greater than or equal to about 1:1. A particularly preferred mole ratio of organic base to azobenzene is about 1.1:1 to about 6:1.

It may be desirable to use a combination of an inorganic salt with a metal organic salt, two or more inorganic salts and/or two or more metal organic salts in case one of the salts that is otherwise effective for use in the process of the invention has a corrosive effect on the equipment used with the process. The combination might also provide better results than could be obtained with one salt.

The expensive part of tetraalkylammonium PTCs and bases is the tetraalkylammonium cation. Some of the PTCs defined by formula II are particularly stable with respect to decomposition of the cation. Moreover, use of a strong inorganic base in combination with the PTCs stabilizes the cation. Furthermore, the use of inorganic salts and/or metal organic salts in combination with an organic base reduces undesirable decomposition of the base cation.

In the process according to the second embodiment of the invention, it should be noted that an organic base with an inorganic salt and/or a metal organic salt will give some in situ formation of the equivalent inorganic base and a phase transfer catalyst, wherein the anion in formula II for the so formed phase transfer catalyst is the anion from the salt. For example, tetramethylammonium hydroxide plus potassium chloride will give some KOH plus tetramethylammonium chloride. Moreover, in an aqueous solution, both systems will give the same mixture of ions. Thus, KOH and tetramethylammonium chloride give the same mixture of ions as KCl and tetramethylammonium hydroxide. So, equivalent results can be expected whether starting with an inorganic base and a phase transfer catalyst or an organic base with an inorganic salt and/or a metal organic salt.

A particularly preferred combination of strong base and phase transfer catalyst is cesium hydroxide and tetraalkylammonium halide. A preferred halide is fluoride. A particularly preferred combination of organic base and inorganic salt is tetraalkylammonium hydroxide and a salt in which the anion is a halide, such as cesium halide. A preferred halide anion is fluoride. The above reactions of organic base and inorganic salt would be carried out initially in aqueous solution in order to get the same mixture of ions as the corresponding strong base and phase transfer catalyst. All of the above reactions could be carried out with a continuous distillation of aniline-water azeotrope, for all or a part of the reaction period.

The reactive contact of the process of the invention may be carried out in the presence of an added oxidant, which may be free oxygen, or comprise an oxidizing agent, such as a peroxide, particularly hydrogen peroxide. The oxidant may be added subsurface or above surface to the reaction medium and can be added all at the start of reaction, at any time during the reaction period or throughout the reaction period. Azo compounds may also function as an oxidizing agent. When the oxidant is applied for the entire reaction period, free oxygen is excluded as an oxidant for the third embodiment, for a strong base that can also function as a phase transfer catalyst.

When an oxidant is added, substituted azo compounds are produced, as the substituted hydrazo compounds formed are oxidized to the respective azo compounds. The substituted hydrazo compounds formed when an oxidant is not added can be partly or wholly oxidized to the substituted azo compound by the starting azo containing compound, even when not used in excess, wherein the hydrazo compound corresponding to the starting azo containing compound is also formed. Also, depending on the reaction conditions, the substituted hydrazo compounds formed can disproportionate to aminoaromatic amines and aminoaromatic amides. See Stern, M. K. et al, J. Org. Chem., 59, 5627-5632 (1994). Hydrazo compounds can be used as the azo containing compound in the first three embodiments when an oxidant is added, as the respective azo compound is formed in situ. When azoxy compounds are used as the azo containing compound in the first three embodiments, substituted azo compounds are produced without need for an oxidant, as the substituted N-(hydroxy)hydrazo compounds that are formed eliminate water to directly form the substituted azo compounds.

In the process of the invention, the oxidant may advantageously need to be present only for part of the time during which the aniline, benzamide or urea and the azo containing compound react. The oxidant may also be used in quantities less than equimolar to the azobenzene compound. In certain systems for the process of the invention, an optimum amount of oxidant can be expected. Such partial oxidative conditions are particularly effective for improving selectivity. One of these instances is when TMAH is used as a strong base that can also function as a phase transfer catalyst for the third embodiment.

The reactive contact may be carried out at a temperature of from about 20° C. to about 150° C. The optimum temperature and effective range will vary with the combination of inorganic base and PTC or organic base and inorganic salt/metal organic salt, or the particular strong base that can also act as a phase transfer catalyst. Other conditions for the reactive contact include pressures in the range of from about 20 mbar to about 20 barg. It is advantageous to agitate the reaction mixture during the entire reaction.

The reaction of step (b) of the first three embodiments of the present method is sensitive to the amount of water present. In general, it may be carried out in the presence of not greater than about 10:1 moles water to moles azobenzene. The reaction may be carried out with a continuous removal of water by distillation. However, the effective limit will vary with the combination of inorganic base and PTC or organic base and inorganic salt/metal organic salt, or the particular strong base that can also act as a phase transfer catalyst. For example, the combination of KOH/TMACI becomes ineffective at much lower levels of water than does CsOH/TMAF. Moreover, the reaction does not proceed well if there is no water present at the start of reaction. The effective range for water/azobenzene mole ratio can be determined for each combination by one skilled in the art. Techniques for optimizing water level include, but are not limited to, varying initial water level, adding water during reaction, removing water during reaction by azeotropic distillation with aniline, varying temperature and pressure to vary the amount of water removed, varying the water removal profile, and removing water during reaction by addition of a desiccant. Examples of suitable desiccants include, but are not limited to, anhydrous sodium sulfate, molecular sieves, such as types 4A, 5A and 13X available from Dow Chemical Company, calcium chloride, anhydrous bases such as KOH and NaOH and activated alumina.

The method of the present invention for the preparation of 4-ADPA or p-PDA intermediates or substituted derivatives thereof and 4-ADPA or p-PDA or substituted derivatives thereof and alkylated derivatives therefrom may be conducted as a batch process or may be performed continuously using means and equipment well known to the skilled person.

The reactive contact in step (a) of the first three embodiments of the method of the invention may occur in a suitable solvent system. A suitable solvent system comprises a polar aprotic solvent. The polar aprotic solvent may be selected from the group consisting of, but not limited to, dimethyl sulfoxide, benzyl ether, 1-Methyl-2-pyrrolidinone and N,N-dimethylformamide. Other suitable solvent systems are described in U.S. Pat. No. 5,451,702 and related patents cited above.

Aminolysis of substituted aromatic amines containing an aromatic amide bond, which can be prepared according to the invention, can be conducted by reacting the aminoaromatic amide with an amine, such as ammonia, to produce the amide and the respective aminoaromatic amine, as described U.S. Pat. No. 5,451,702 and related patents cited above. So if the starting amide has a —NH₂ group, aminolysis with ammonia will regenerate the starting amide that can be recycled. Similarly, aminolysis with aniline will yield the N-(phenyl)amide and the respective aminoaromatic amine. So if the starting amide is a N-(phenyl)amide, the starting amide will be regenerated and the corresponding amine will be the respective arylamino aromatic diamine. Furthermore, when the starting amide is not regenerated by aminolysis, it is possible to convert the amide so formed to the starting amide in a separate step for recycle. Similarly, amido substituted aromatic azo and/or hydrazo compounds can be converted to the respective amide and the amino substituted aromatic azo and/or hydrazo compounds.

Ammonium hydroxide can also be used to convert the various substituted amides to the corresponding amines, as described in U.S. Pat. No. 5,331,099. In this case, the corresponding amide can be a mixture of the starting amide and the acid corresponding to the starting amide. Mixtures of ammonia and ammonium hydroxide are also acceptable.

Hydrolysis of substituted aromatic amines containing an aromatic amide bond can be conducted by reacting the amide with water in the presence of a suitable basic or acidic catalyst to produce the respective aminoaromatic amines and the acid or salt thereof corresponding to the starting amide, which can be converted to the starting amide in a separate step for recycle. Similarly, amidoaromatic azo and/or hydrazo compounds can be converted to the amino substituted aromatic azo and/or hydrazo compounds and the acid or salt thereof corresponding to the starting amide.

The method of the invention includes the additional steps wherein the amino substituted aromatic azo and/or hydrazo compounds are reduced to aminoaromatic amines. In another aspect, the amidoaromatic azo and/or hydrazo compounds are reduced to aminoaromatic amides. The reduction can be carried out by any known method, including the use of hydrogen that involves the use of a hydrogenation catalyst. Details concerning choice of catalyst and other aspects of the hydrogenation reaction and examples of other reductions may be found in U.S. Pat. No. 6,140,538 and U.S. Pat. No. 5,331,099, both incorporated by reference herein, and U.S. Pat. No. 5,451,702.

Other means of reduction, which do not involve the direct use of hydrogen and are known to one skilled in the art, can also be used to reduce the 4-ADPA (or p-PDA) intermediates or substituted derivatives thereof to 4-ADPA (or p-PDA) or substituted derivatives thereof. This includes reduction by alcohols, with or without a catalyst, where suitable alcohols are defined in U.S. Pat. No. 5,382,691. The alcohols can be primary, secondary or tertiary alcohols selected from the group consisting of aliphatic alcohols, cycloaliphatic alcohols, arylalkyl alcohols and mixtures thereof. Examples of suitable alcohols include, but are not limited to, isopropanol, isoamyl alcohol, 3-methyl-2-buten-1-ol, n-butanol, sec-butanol, tert-butanol, 1,3-dimethylbutanol, n-octanol, cyclopropanol, cyclohexanol, 2-cyclohexen-1-ol, cyclooctanol, benzyl alcohol, 1-phenyl-2-butanol, 6-phenyl-1-hexanol, 2-(1-naphthyl)ethanol, and the like and mixtures thereof.

The present invention further relates to a process for preparing alkylated derivatives of p-phenylenediamines, including monoalkyl, dialkyl and alkyl-aryl p-phenylenediamines or substituted derivatives thereof, in particular for preparing Nalkyl derivatives of p-phenylenediamine and 4-ADPA and substituted derivatives thereof, which are useful for the protection of rubber products, in which process the p-aminoaromatic amines, p-aminoaromatic azo compounds, p-aminoaromatic hydrazo compounds, or substituted derivatives thereof, obtained according to the invention, are reduced according to the invention process, during or after which the reduced products so obtained are reductively alkylated to an alkylated derivative of p-PDA or 4-ADPA or substituted derivatives thereof, according to methods known to the person skilled in this technical field. Typically, the p-PDA or 4-ADPA or substituted derivatives thereof and a suitable ketone or aldehyde are reacted in the presence of hydrogen and platinum-on-carbon as catalyst. Suitable ketones include methylisobutyl ketone, acetone, methylisoamyl ketone, and 2-octanone. See for example U.S. Pat. No. 4,463,191, incorporated by reference herein, U.S. Pat. No. 5,451,702 and related patents cited above, and Banerjee et al, J. Chem. Soc. Chem. Comm. 18, 1275-1276 (1988). Suitable catalysts can be the same as, but not limited to, those described above for the reduction process. Similarly, aminoaromatic amides, or amido substituted aromatic azo compounds, or amido substituted aromatic hydrazo compounds, obtained according to the invention, can be reductively alkylated to N-(alkyl)aromatic amides.

In a preferred embodiment of the invention, the reduction is conducted in the presence of water, e.g. water is added to the reaction mixture. The use of water is particularly advantageous when the suitable base, used during the reaction of the nucleophilic compound and azo containing compound, is water-soluble. When the base is water-soluble, the amount of water added is preferably at least the amount needed to extract the base from the organic phase and/or dissolve solid base. Similarly, the addition of water is also preferred for reductive alkylation, if it is carried out in the presence of the suitable base that is water-soluble.

If an amido or diamido substituted azobenzene and/or an amido or diamido substituted hydrazobenzene is reduced in the presence of water and a suitable basic or acidic catalyst, at conditions that do not reduce the amide carbonyl group, then it is possible for hydrolysis of the amide group to occur in parallel to hydrogenation of the azo or hydrazo group, to produce the aryl amine and/or diamine and the acid or salt thereof corresponding to the starting amide. Moreover, if the hydrogenation is carried out in the presence of ammonia, at conditions that do not reduce the amide carbonyl group, then it is possible for aminolysis of the amide group to occur in parallel to hydrogenation of the azo or hydrazo group, to produce the aryl amine and/or diamine and the corresponding amide. Similarly, if an amido or diamido substituted azobenzene and/or an amido or diamido substituted hydrazobenzene and/or an amido substituted amine is reductively alkylated in the presence of water, at conditions that do not reduce the amide carbonyl group, then it is possible for hydrolysis of the amide group to occur in parallel to reductive alkylation of the amine groups, including those amine groups generated by reduction of the azo and/or hydrazo groups and/or by hydrolysis of the amide groups, to produce the alkylated amines and/or dialkylated aryl diamines and the acid or salt of the starting amide. Furthermore, if the reductive alkylation is carried out in the presence of ammonia, at conditions that do not reduce the amide carbonyl group, then it is possible for aminolysis of the amide group to occur in parallel to reductive alkylation of the amine groups, including those amine groups generated by reduction of the azo and/or hydrazo groups and/or by hydrolysis of the amide groups, to produce the alkylated amines and/or dialkylated aryl diamines and the corresponding amide.

The aqueous phase may be reused to form a new reaction mixture. Fresh strong base and phase transfer catalyst, or organic base with or without inorganic salt and/or metal organic salt are added to replace losses by decomposition, by-product formation and solubility in the separated organic phase. Excess aniline, benzamide, urea or azobenzene recovered from the reaction product mixture may be combined with make-up fresh aniline, benzamide, urea or azobenzene for recycle to form a new reaction mixture. Excess azobenzene can also be reduced to aniline.

The invention may be illustrated by the following non-limiting examples.

### EXAMPLES

Analytical

Yields of individual components were determined by external standard HPLC, from the average of duplicate analyses. Approximately 0.06 grams of material to be analyzed is accurately weighed into a 50-mL volumetric flask and diluted with a buffer solution containing 39% v/v water, 36% v/v acetonitrile, 24% v/v methanol and 1% v/v pH 7 buffer. Eluant A is 75% v/v water, 15% v/v acetonitrile and 10% v/v methanol. Eluant B is 60% v/v acetonitrile and 40% v/v methanol. Detection is UV at 254 nm. The solution is injected through a 10 μL loop onto a reversed phase Zorbax ODS HPLC column (250×4.6 mm) using a binary gradient pumping system and the following elution gradient at a constant flow rate of 1.5 mL/minute:

| Time, minutes | % Eluant A | % Eluant B |
|---|---|---|
| 0 | 100 | 0 |
| 25 | 25 | 75 |
| 35 | 0 | 100 |
| 37.5 | 0 | 100 |
| 38 | 100 | 0 |
| 40 | 100 | 0 |

### Experimental

Experimental procedures are described within each example.

HPLC compositions are normalized for all organic compounds, so that any water dissolved in the reaction mass is not included. For experiments at 760 torr, the molar amount of each component is calculated from the normalized wt. % times the charge of (aniline+azobenzene) divided by the molecular weight. This can not be done for azeotropic distillation experiments, due to the removal of some aniline. So normalized weight percents are converted to normalized mole percents, which are used to calculate conversion, yield and selectivity. 4-methoxy-azobenzene and azobenzene can not be completely separated on the HPLC, so the amounts of each are estimated from formation of other components.

Conversion for 760 torr runs is calculated as moles of azobenzene products [PADPA (4-phenylazo-diphenylamine)+alkoxy-azobenzene+unknowns], divided by the molar azobenzene charge. PADPA's molecular weight is arbitrarily used for unknowns, which is of small consequence due to the low level of unknowns. Yield of PADPA is calculated as moles of PADPA divided by the molar azobenzene charge. For azeotropic runs, conversion was calculated as mole % of azobenzene products divided by mole % of [azobenzene+azobenzene products]. Yield was calculated as mole % of PADPA divided by mole % of [azobenzene+azobenzene products]. Selectivity was calculated as Yield/Conversion for all runs. The following mole ratio was used as an indicator of TMAH or PTC decomposition per unit of PADPA yield (i.e. decomposition ratio):

(N-alkyl-aniline/TMAH or PTC charge)/(PADPA/azobenzene charge).

### Comparative Example 1

This example was an attempt to obtain results comparable to those reported in Example 5 of U.S. Pat. No. 5,382,691 (Example 17 of WO 93/24450). It was found that reaction between aniline and azobenzene to make 4-ADPA intermediates is not as easy as reported in the prior art.

a) To an agitated 50-mL glass reactor equipped for vacuum removal of water and aniline, was charged 10 mL of aqueous, 25 wt. % TMAH (28 mmoles). Water was distilled out at 60° C. and 20 torr to dryness (formation of a solid precipitate). Then 5 mL of aniline (99%, 54 mmoles) and 1.82 g of azobenzene (98%, 9.8 mmoles) were added and vacuum distillation continued.

b) To the reactor was charged 5.04 g of solid TMAHx5H₂O (97%, 27 mmoles), 10 mL of aniline (99%, 108 mmoles) and 1.82 g of azobenzene (9.8 mmoles). The use of TMAHx5H₂O eliminated the base drying step. The mixture was reacted at 60° C. and 20 torr with azeotropic removal of water and aniline.

c) To the reactor was charged 9.79 g of solid TMAHx5H₂O (54 mmoles), 9.69 g of aniline (99%, 103 mmoles) and 3.64 g of azobenzene (98%, 19.6 mmoles). The mass was reacted at 80° C. and 20 torr with azeotropic removal of water and aniline.

Results in Table 1 show that the reference results could not be reproduced, as yield was far short. Increasing reaction time and increasing the An/Azo mole ratio (from below the reference to above) did increase conversion and yield, but again far short of the reference result. Higher temperature greatly increased conversion of azobenzene and yield of PADPA, but still short of the reference. Moreover, selectivity decreased greatly to be much lower than for Runs C1a) and C1b) and TMAH decomposition increased by a factor of about 20. The reference example does not state whether the 99% yield is based on azobenzene charged or reacted. In this work azobenzene and methoxy-azobenzene eluted very close together on the HPLC. So it appears that yield in the reference was for azobenzene reacted, but mistook 4-methoxy-azobenzene for unreacted azobenzene.

TABLE 1
Comparative Example - Investigation of Prior Art

| | | Reaction | Con- | | | De- |
|---|---|---|---|---|---|---|
| Run | | Time | version | Yield | Selectivity | comp. |
| Nr. | An/TMAH/Azo | (h) | (%) | (%) | (%) | Ratio |
| Ref. | 8.1/2.07/1 | 4 | | 99 | | 0.091 |
| C1a) | 5.5/2.86/1 | 4 | 3.4 | 3.1 | 90.9 | 0.00 |
| | | 8 | 9.1 | 8.4 | 92.5 | 0.00 |
| C1b) | 11/2.76/1 | 4 | 12.0 | 11.2 | 93.8 | 0.024 |
| | | 7 | 23.1 | 21.7 | 93.6 | 0.026 |
| C1c) | 5.3/2.76/1 | 4 | 88.7 | 35.1 | 39.6 | 0.51 |
| | | 6 | 87.7 | 32.9 | 37.5 | 0.54 |

### Comparative Example 2

This example compares TMAH with KOH/TMACI for reaction with azeotropic removal of water and aniline.

a) To an agitated 50-mL glass reactor equipped for vacuum, was charged 7.47 g of solid TMAHx5H₂O (97%, 40 mmoles), 18.81 g of aniline (99%, 200 mmoles) and 3.72 g of azobenzene (98%, 20 mmoles). The mixture was reacted for 6 hours at 68° C. and 10 torr, with azeotropic removal of water and aniline.

b) To the above reactor was charged 4.49 g of aqueous 50 wt. % KOH (40 mmoles), 5.26 g of aqueous 50 wt. % TMACI (24 mmoles), 18.81 g of aniline (99%, 200 mmoles) and 3.72 g of azobenzene (98%, 20 mmoles). The mixture was reacted for 8 hours at 68° C. and 10 torr, with azeotropic removal of water and aniline. The reactor contents became entirely solid at 3 hours, so 5 mL of water and 8 mL of aniline from the overhead receiver were added to the reactor.

The results in Table 2 show much higher conversion and yield with TMAH, but also much lower selectivity and much higher decomposition of TMAH vs. TMACI. The reaction with KOH/TMACI was still progressing at 8 hours, so conversion could be further increased with essentially no loss of selectivity or increase of decomposition by reacting for a longer time. In any case, higher selectivity and less decomposition with KOH/TMACI indicate overall better results vs. TMAH if unreacted azobenzene is recovered for recycle.

TABLE 2
Comparative Example - TMAH vs. KOH/TMACl

| | | Reaction | Con- | | Selec- | |
|---|---|---|---|---|---|---|
| Run | | Time | version | Yield | tivity | Decomp. |
| Nr. | Base/PTC | (h) | (%) | (%) | (%) | Ratio |
| C2a) | TMAHx5H₂O | 3 | 92.2 | 49.7 | 53.9 | 0.75 |
| | (50% water) | 6 | 93.7 | 50.4 | 53.8 | 0.79 |
| C2b) | KOH/TMACl | 3 | 5.0 | 4.0 | 80.7 | 0.19 |
| | (each as | 6 | 11.4 | 8.8 | 77.9 | 0.23 |
| | 50% water) | 8 | 13.7 | 10.7 | 78.3 | 0.22 |

### Comparative Example 3

This example demonstrates that the reaction of aniline with azobenzene does not proceed without the presence of a PTC. The reaction procedure is the same as described in Example 3, except that the PTC was omitted. The yield was only 0.1%.

### Example 1

This example compares inorganic bases for efficacy in promoting the reaction of aniline with azobenzene in the presence of a PTC. All reactions ran for 3 hours at 80° C., 760 torr and An/Base/PTC/Azo=7.5/2.5/1.25/1 with an air sweep.

a) To an agitated, 50-mL glass reactor was charged 14.11 g of aniline (99%, 150 mmoles), 3.72 g of azobenzene (98%, 20 mmoles), 8.84 g of CsOHxH₂O (96%, 50 mmoles) and 2.85 g of TMACI (96%, 25 mmoles).

b) To the above reactor was charged 21.17 g of aniline (99%, 225 mmoles), 5.58 g of azobenzene (98%, 30 mmoles), 4.89 g of KOHx0.5H₂O (75 mmoles) and 4.28 g of TMACI (96%, 37.5 mmoles).

c) To the above reactor was charged 21.17 g of aniline (99%, 225 mmoles), 5.58 g of azobenzene (98%, 30 mmoles), 3.03 g of NaOH (99%, 75 mmoles) and 4.28 g of TMACI (96%, 37.5 mmoles).

The results in Table 3 show a periodic trend in going from Na to Cs, in terms of increasing conversion, yield and selectivity with decreasing decomposition of TMACI. CsOH is by far the most effective of the three bases and with an efficient base recycling system, the use of CsOH would be cost effective.

TABLE 3
Comparison of Different Bases

| Run | | Conversion | Yield | Selectivity | Decomposition |
|---|---|---|---|---|---|
| Nr. | Base | (%) | (%) | (%) | Ratio |
| 1a) | CsOHxH₂O | 44.6 | 29.2 | 65.4 | 0.32 |
| 1b) | KOHx0.5H₂O | 30.2 | 17.6 | 58.3 | 0.54 |
| 1c) | NaOH | 1.5 | 0.26 | 18.0 | 2.81 |

### Example 2

This example illustrates the effect of Base/Azo mole ratio on the reaction of aniline with azobenzene in the presence of a PTC. All reactions were run at 80° C. and 760 torr for 3 hours with an air sweep. To an agitated, 50-mL glass reactor was charged 21.17 g of aniline (99%, 225 mmoles), 5.58 g of azobenzene (98%, 30 mmoles) and 4.28 g of TMACI (96%, 37.5 mmoles). The charge of KOHx0.5H₂O varied as shown in Table 4. The results indicate that increasing Base/Azo increases conversion, yield and selectivity and decreases TMACI decomposition.

TABLE 4
Effect of Base/Azo Mole Ratio

| Run | KOH/Azo | Conversion | Yield | Selectivity | Decomposition |
|---|---|---|---|---|---|
| Nr. | Molar | (%) | (%) | (%) | Ratio |
| 2a) | 1.25 | 10.9 | 4.4 | 40.0 | 1.10 |
| 2b) | 2.50 | 30.2 | 17.6 | 58.3 | 0.54 |
| 2c) | 3.75 | 39.1 | 24.8 | 63.5 | 0.45 |

### Example 3

This example illustrates the effect of PTC/Azo mole ratio on the reaction of aniline with azobenzene in the presence of an inorganic base. All reactions were run at 80° C. and 760 torr for 3 hours with an air sweep. To an agitated, 50-mL glass reactor was charged 21.17 g of aniline (99%, 225 mmoles), 5.58 g of azobenzene (98%, 30 mmoles) and 4.89 g of KOHx0.5H₂O (75 mmoles). The charge of TMACI (96%, 37.5 mmoles) varied as indicated in Table 5.

The results in Table 5 show that increasing PTC/Azo significantly increased conversion and yield, but gave a surprisingly small increase in selectivity. TMACI decomposition was reduced by more than half by doubling PTC/Azo. So although the reaction proceeds with a less than molar amount of PTC, much better results are obtained with a molar excess.

TABLE 5
Effect of PTC/Azo Mole Ratio

| Run | PTC/Azo | Conversion | Yield | Selectivity | Decomposition |
|---|---|---|---|---|---|
| Nr. | molar | (%) | (%) | (%) | Ratio |
| 3a) | 0.0 | 2.9 | 0.1 | 3.5 | 0.0 |
| 3b) | 0.625 | 18.3 | 10.0 | 54.5 | 1.24 |
| 3c) | 1.25 | 30.2 | 17.6 | 58.3 | 0.54 |

### Example 4

This example illustrates the effect of H₂O/PTC mole ratio on the reaction of aniline with azobenzene in the presence of an inorganic base and a PTC. All reactions were run at 80° C. and 760 torr for 3 hours with an air sweep. To an agitated, 50-mL glass reactor was charged 21.17 g of aniline (99%, 225 mmoles), 5.58 g of azobenzene (98%, 30 mmoles), 4.89 g of KOHx0.5H₂O (75 mmoles) and 4.28 g of TMACI (96%, 37.5 mmoles). The charge of water varied as shown in Table 6.

The results in Table 6 indicate that increasing H₂O/PTC dramatically reduced conversion and yield, reduced selectivity to a lesser degree and gave a surprisingly small reduction of decomposition. So water has a significant impact on the reaction of aniline with azobenzene. This is further illustrated in Example 5.

TABLE 6
Effect of H₂O/PTC Mole Ratio

| Run | H₂O/PTC | Conversion | Yield | Selectivity | Decomposition |
|---|---|---|---|---|---|
| Nr. | Molar* | (%) | (%) | (%) | Ratio |
| 4a) | 1.0 | 30.2 | 17.6 | 58.3 | 0.54 |
| 4b) | 3.5 | 7.8 | 4.3 | 54.6 | 0.47 |
| 4c) | 6.0 | 1.2 | 0.6 | 51.4 | 0.47 |

*Includes the hydrated water added with KOH (H₂O/PTC = 1)

### Example 5

This example further illustrates the effect of water. Both reactions were carried out at 68° C. and 10 torr, with azeotropic removal of water and aniline.

a) To an agitated, 50-mL glass reactor was charged 4.49 g of aqueous 50 wt. % KOH (40 mmoles), 5.26 g of aqueous 50 wt. % TMACI (24 mmoles), 18.81 g of aniline (99%, 200 mmoles) and 3.72 g of azobenzene (98%, 20 mmoles). The mixture was reacted for 8 hours. The reactor contents became entirely solid at 3 hours, so 5 mL of water and 8 mL of aniline from the overhead receiver were added to the reactor.

b) To the above reactor was charged 5.21 g of KOHx0.5H₂O (80 mmoles), 4.57 g of TMACI (96%, 40 mmoles), 18.81 g of aniline (99%, 200 mmoles) and 3.72 g of azobenzene (98%, 20 mmoles). An additional 5 mL of aniline was added at 4 hours. The mixture was reacted for 6 hours.

Table 7 shows that more water for the start of reaction improves conversion, yield and selectivity, but the results do not show up until after about 3 hours. Moreover, TMACI decomposition for the two cases was equivalent at 3 hours, but decidedly better at 6 hours for the higher water case. Even the use of higher mole ratios of Base/Azo and PTC/Azo did not help the reaction with the drier start. This shows that for the higher water start, some of the initial water remains after 3 hours of azeotropic removal. Therefore, this example indicates that some water is needed to promote the reaction of aniline with azobenzene, whereas Example 4 shows that too much water hurts the reaction. So there must be an optimum amount of water, which can be controlled by how much is added and by how much is removed during the reaction (which generates more water).

TABLE 7
Effect of Water with Azeotropic Removal of Water

| | | Reaction | Con- | | | De- |
|---|---|---|---|---|---|---|
| Run | | Time | version | Yield | Selectivity | comp. |
| Nr. | Base/PTC | (h) | (%) | (%) | (%) | Ratio |
| 5a) | KOH/TMACl | 3 | 5.0 | 4.0 | 80.7 | 0.19 |
| | (each as | 6 | 11.4 | 8.8 | 77.9 | 0.23 |
| | 50% water) | 8 | 13.7 | 10.7 | 78.3 | 0.22 |
| | Mole ratios are An/Base/PTC/Azo = 10/2/1.2/1 | | | | | |
| 5b) | KOH/TMACl | 3 | 5.0 | 3.6 | 71.5 | 0.20 |
| | | 6 | 6.2 | 3.5 | 56.8 | 0.37 |

Mole ratios are An/Base/PTC/Azo = 10/4/2/1

### Example 6

This example compares various phase transfer catalysts for efficacy in promoting the reaction of aniline with azobenzene in the presence of an inorganic base. All reactions were run at 80° C. and 760 torr for 3 hours in an agitated 50-mL glass reactor with an air sweep. The base was KOHx0.5H₂O. TMAH was included as a base that can also act as a PTC. The charges are tabulated below.

TABLE 8
Starting Reaction Mixtures for Example 6

| Run | Aniline | | Azobenzene | | Base | | PTC | |
|---|---|---|---|---|---|---|---|---|
| Nr. | g | mmoles | g | mmoles | g | mmoles | g | mmoles |
| 6a) | 14.11 | 150 | 3.72 | 20 | 3.26 | 50 | 4.21 | 25 |
| 6b) | 21.17 | 225 | 5.58 | 30 | 4.89 | 75 | 4.28 | 37.5 |
| 6c) | 14.11 | 150 | 3.72 | 20 | 3.26 | 50 | 7.09 | 25 |

Mole ratios for above three runs are: An/Base/PTC/Azo = 7.5/2.5/1.25/1

| | | | | | | | | |
|---|---|---|---|---|---|---|---|---|
| 6d) | 25 | 275 | 4.65 | 25 | 8.16 | 125 | 8.14 | 25 |
| | mL | | | | | | | |

Mole ratios for above run are: An/Base/PTC/Azo = 11/5/1/1

| | | | | | | |
|---|---|---|---|---|---|---|
| 6e) | 21.17 | 225 | 5.58 | 30 | 7.01 | 37.5 |

Mole ratios for above run are: An/Base(PTC)/Azo = 7.5/1.25/1

The results are presented in Table 9. TMAFx4H₂O gave higher selectivity and much lower decomposition than TMACI, but lower conversion. The lower conversion was most likely due to the water added with TMAFx4H₂O, as illustrated in Example 4 above when water was added with TMACI. So it is concluded that TMAF is a better PTC than TMACI. TBACIxH₂O is much less effective than TMACI and the water added is too low to be the cause. The likely cause is steric hindrance from the larger butyl groups vs. methyl groups. TBABr is much less effective than TBACI, despite higher mole ratios of An/Base/Azo (Example 3 shows that the slightly lower PTC/Azo mole ratio for TBABr is not enough to explain the large difference in results). Together with TMAF vs. TMACI, this gives a trend of increasing efficacy for going up the periodic table from Br to F. The very poor results for TMAHx5H₂O must be due to water. The reaction ran much better with TMAHx5H₂O in reactions with azeotropic removal of water (Comparative Examples 1 and 2). The lower Base/Azo mole ratio for this example is not enough for such poor results. The conclusion from this example is that PTC's other than TMACI are effective for promoting the reaction of aniline with azobenzene. It can be expected that a range of PTC's, such as described in U.S. Pat. No. 6,395,933 B1, will be effective to varying degrees.

TABLE 9
Comparison of Phase Transfer Catalysts

| | | | | | Decom- |
|---|---|---|---|---|---|
| Run | | Conversion | Yield | Selectivity | position |
| Nr. | PTC | (%) | (%) | (%) | Ratio |
| 6a) | TMAFx4H₂O (98%) | 24.5 | 18.0 | 73.6 | 0.13 |
| 6b) | TMACl (96%) | 30.2 | 17.6 | 58.3 | 0.54 |
| 6c) | TBAClxH₂O (98%) | 3.2 | 0.51 | 16.2 | 1.6 |
| 6d) | TBABr (99%) | 0.27 | 0.27 | 100.0 | 0.0 |
| 6e) | TMAHx5H₂O (97%) | 0.93 | 0.55 | 59.2 | 0.22 |

### Example 7

This example illustrates the effect of temperature on the reaction of aniline with azobenzene in the presence of an inorganic base and a PTC. All reactions were run at 760 torr for 3 hours with an air sweep. To an agitated, 50-mL glass reactor was charged 21.17 g of aniline (99%, 225 mmoles), 5.58 g of azobenzene (98%, 30 mmoles), 4.89 g of KOHx0.5H₂O (75 mmoles) and 4.28 g of TMACI (96%, 37.5 mmoles). The temperature varied as shown in Table 10.

The results in Table 10 indicate that as can be expected, conversion of azobenzene increased as reaction temperature was increased. However, yield did not increase above 80° C., whereas selectivity decreased steadily and decomposition of TMACI increased steadily. So side reactions and TMACI decomposition are promoted more by increasing temperature than is the formation of PADPA. It is expected that the amount of water in the reaction mixture will have some influence on the optimum temperature. However, even with an optimum amount of water, it does appear that 90° C. is too high for the KOH/TMACI system. It can also be expected that the optimum temperature will vary with the base and PTC used in addition to the water content. So these results do not preclude a different optimum temperature for other Base/PTC combinations.

TABLE 10
Effect of Temperature

| Run | Temperature | Conversion | Yield | Selectivity | Decomposition |
|---|---|---|---|---|---|
| Nr. | (° C.) | (%) | (%) | (%) | Ratio |
| 7a) | 70 | 14.9 | 10.2 | 68.2 | 0.32 |
| 7b) | 80 | 30.2 | 17.6 | 58.3 | 0.54 |
| 7c) | 90 | 40.8 | 17.3 | 42.5 | 1.03 |

### Example 8

This example illustrates the effect of oxygen on the reaction of aniline with azobenzene in the presence of an inorganic base and a PTC. Both reactions were run at 80° C. and 760 torr for 3 hours. Charged to an agitated, 50-mL glass reactor was 21.17 g of aniline (99%, 225 mmoles), 5.58 g of azobenzene (98%, 30 mmoles), 4.89 g of KOHx0.5H₂O (75 mmoles) and 4.28 g of TMACI (96%, 37.5 mmoles). The results show that the reaction is favored by aerobic conditions. It is suspected that oxygen increases yield and selectivity by oxidizing an intermediate to PADPA before the intermediate can react to by-products or revert to starting compounds.

TABLE 11
Effect of Oxygen

| Run | | Conversion | Yield | Selectivity | Decomposition |
|---|---|---|---|---|---|
| Nr. | Atmosphere | (%) | (%) | (%) | Ratio |
| 8a) | Air | 30.2 | 17.6 | 58.3 | 0.54 |
| 8b) | Nitrogen | 26.3 | 10.7 | 40.7 | 1.04 |

### Example 9

This example presents a reaction profile over a 30 hour period for reaction at 75° C. and 760 torr. To an agitated, 50-mL glass reactor was charged 18.81 g of aniline (99%, 200 mmoles), 4.65 g of azobenzene (98%, 25 mmoles), 4.08 g of KOHx0.5H₂O (62.5 mmoles) and 3.28 g of TMACI (96%, 28.75 mmoles).

The results show that the coupling reaction of aniline with azobenzene continued to proceed slowly over a 30 hour period with no indication that it was ready to stop. Over this extended period, selectivity dropped only slightly and decomposition increased only slightly. This indicates that the reaction will proceed under the right conditions. Furthermore, the reaction should go much faster with higher selectivity and lower decomposition, by using certain combinations of base and PTC, such as CsOH/TMAF, and with the optimum amount of water present.

[image]

### Example 10

This example uses the best base (CsOH) with the best PTC (TMAF) from the other examples. Reaction conditions were the same as in Examples 1 a) and 6a), so all runs in Table 12 had equal mole ratios; An/Base/PTC/Azo=7.5/2.5/1.25/1. This combination of base and PTC gave better conversion and yield than KOH with TMAF and better selectivity than CsOH with TMACI. The overall results are the best of any combination for the examples run at these conditions. This combination also had the highest amount of hydrated water (H₂O/PTC=6) for all of the runs done at 760 torr. The results of Example 4 show that when water was added to the system of KOH/TMACI to give H₂O/PTC=6, conversion fell to 1.2%. That makes the results for CsOH/TMAF even better by comparison.

TABLE 12
Comparison of CsOH + TMAF Combination

| Run | | | Conversion | Yield | Selectivity | Decomp. |
|---|---|---|---|---|---|---|
| Nr. | Base | PTC | (%) | (%) | (%) | Ratio |
| 1a) | CsOHxH₂O | TMACl | 44.6 | 29.2 | 65.4 | 0.32 |
| 10 | CsOHxH₂O | TMAFx4H₂O | 28.7 | 20.8 | 72.4 | 0.24 |
| 6a) | KOHx0.5H₂O | TMAFx4H₂O | 24.5 | 18.0 | 73.6 | 0.13 |

### Example 11

Example 10 shows that it should be possible to increase conversion and yield for CsOH/TMAF by removing some of the hydrated water during reaction. That was done in this example by operating under vacuum, so that water was azeotropically removed with aniline. Charges, mole ratios, reaction time and temperature were the same as in Example 10, but pressure was 20 torr. Table 13 shows that conversion and yield increased significantly from removal of water. Results would have been even better if aniline had been added to replace that which was removed. However, the decomposition ratio increased and selectivity decreased significantly, due to greater TMAF decomposition, as more methylaniline and methoxy-azobenzene (MeO-Azo) were made. Water protects against decomposition, so too much water was removed for optimum selectivity. One skilled in the art should be able to determine the temperature, pressure, initial water level and water removal profile for vacuum operation to obtain optimum conversion, yield, selectivity and decomposition. It should be possible to further improve results by adding an oxidant during reaction, such as hydrogen peroxide.

TABLE 13
Comparison of CsOH + TMAF Combination

| | | Con- | | | | |
|---|---|---|---|---|---|---|
| Run | Reaction | version | Yield | Selectivity | Decomp. | MeO-Azo |
| Nr. | Operation | (%) | (%) | (%) | Ratio | (wt. %) |
| 11 | Azeotropic | 92.3 | 53.2 | 57.7 | 0.51 | 7.4 |
| 10 | No Boil-out | 28.7 | 20.8 | 72.4 | 0.24 | 1.4 |

We claim:

1. A process for producing amino or amido substituted aromatic azo or hydrazo compounds, or aminoaromatic amines, or aminoaromatic amides, or mixtures thereof, comprising the steps of:
(a) bringing into reactive contact in a suitable solvent system a nucleophilic compound selected from the group consisting of aniline, substituted aniline derivatives, aliphatic amines, substituted aliphatic amine derivatives, amides and substituted amide derivatives; and
(b) reacting the nucleophilic compound and an azo containing compound in a confined zone at a suitable time, pressure and temperature, in the presence of a mixture comprising a strong base and one or more of a phase transfer catalyst selected from the group of compounds defined by: 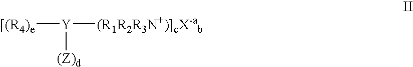
where R₁, R₂, R₃ are the same or different and selected from any straight chain or branched alkyl group containing from C₁ to C₂₀, (R₄)ₑ is hydrogen for e=0, (R₄)ₑ is R₁R₂R₃N⁺ for e=1, 2 or 3, Y is alkyl, aryl, alkyl aryl or benzyl and substituted derivatives thereof, Z is a substituent selected from the group consisting of hydroxyl, halo, and other hetero atoms, X is an anionic moiety of the form fluoride, chloride, bromide, hydroxide, sulfate, hydrogensulfate, acetate, formate, nitrate, phosphate, hydrogen phosphate, dihydrogen phosphate, oxalate, carbonate, bicarbonate, borate, hydrogen borate, dihydrogen borate, silicate, hydrogen silicate, dihydrogen silicate, trihydrogen silicate, cyanide, sulfide, phenolic, tartrate, citrate, malonate and mixtures of said compounds, where a=the valence of the anionic moiety (1, 2, 3 or 4), b and c are whole number integers of value 1, 2, 3 or 4 and d is a whole number integer of value 0 to 4.

2. The process of claim 1 wherein said azo containing compound is represented by the formula:
X—R₁—N═N—R₂—Y I
including azoxy or hydrazo derivatives thereof, wherein R₁ is an aromatic group and R₂ is selected from the group consisting of aliphatic and aromatic groups and X and Y are independently selected from the group consisting of hydrogen, halides, —NO₂, —NH₂, aryl groups, alkyl groups, alkoxy groups, sulfonate groups, —SO₃H, —OH, —COH, —COOH, and alkyl, aryl, alkylaryl or benzyl groups, containing at least one —NH₂ group, wherein if R₂ is aliphatic, X is in the meta or ortho position on R₁, and if R₂ is aromatic, at least one of X and Y is on the meta or ortho position on R₁ and R₂ respectively, and wherein halides are selected from the group consisting of fluoride, chloride, and bromide.

3. The process of claim 1 wherein the amides comprise thioamide and the aliphatic amine comprises aralkyl amine.

4. A process for producing amino or amido substituted aromatic azo or hydrazo compounds, or aminoaromatic amines, or aminoaromatic amides, or mixtures thereof, comprises the steps of:
(a) bringing into reactive contact in a suitable solvent system a nucleophilic compound selected from the group consisting of aniline, substituted aniline derivatives, aliphatic amines, substituted aliphatic amine derivatives, amides and substituted amide derivatives with an azo containing compound; and
(b) reacting the nucleophilic compound and an azo containing compound in a confined zone at a suitable time, pressure and temperature, in the presence of a mixture comprising an inorganic salt or metal organic salt, or mixture thereof, having a cation that would be a suitable cation of a strong inorganic base and one or more of an organic base selected from the group of compounds defined by: 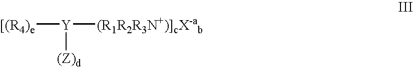
where R₁, R₂, R₃ are the same or different and selected from any straight chain or branched alkyl group containing from C₁ to C₂₀, (R₄)ₑ is hydrogen for e=0, (R₄)ₑ is R₁R₂R₃N⁺ for e=1, 2, or 3, X is an anion capable of abstracting a proton from the nitrogen of an aniline or aniline derivative, Y is alkyl, aryl, alkyl aryl or benzyl and substituted derivatives thereof, Z is a substituent selected from the group consisting of hydroxyl, halo, and other hetero atoms, where a=the valence of the anionic moiety (1, 2, 3 or 4), b and c are whole number integers of value 1, 2, 3 or 4 and d is a whole number integer of value 0 to 4.

5. The process of claim 4 wherein the amides comprise thioamide and the aliphatic amine comprise aralkyl amine.

6. The process of claim 4 wherein said azo containing compound is represented by the formula
X—R₁—N═N—R₂—Y I
including azoxy or hydrazo derivatives thereof, wherein R₁ is an aromatic group and R₂ is selected from the group consisting of aliphatic and aromatic groups and X and Y are independently selected from the group consisting of hydrogen, halides, —NO₂, —NH₂, aryl groups, alkyl groups, alkoxy groups, sulfonate groups, —SO₃H, —OH, —COH, —COOH, and alkyl, aryl, alkylaryl or benzyl groups, containing at least one —NH₂ group, wherein if R₂ is aliphatic, X is in the meta or ortho position on R₁, and if R₂ is aromatic, at least one of X and Y is on the meta or ortho position on R₁ and R₂ respectively, and wherein halides are selected from the group consisting of fluoride, chloride, and bromide.

7. A process for producing amino or amido substituted aromatic azo or hydrazo compounds, or aminoaromatic amines, or aminoaromatic amides, or mixtures thereof, comprises the steps of:
(a) bringing into reactive contact in a suitable solvent system a nucleophilic compound selected from the group of aniline, substituted aniline derivatives, aliphatic amines, substituted aliphatic amine derivatives, amides and substituted amide derivatives with an azo containing compound; and
(b) reacting the nucleophilic compound and the azo containing compound in a confined zone at a suitable time, pressure and temperature, in the presence of a mixture comprising an oxidant and a strong base that also functions as a phase transfer catalyst selected from the group of compounds defined by: 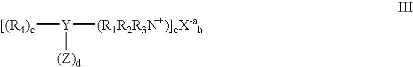
where R₁, R₂, R₃ are the same or different and selected from any straight chain or branched alkyl group containing from C₁ to C₂₀, (R₄)ₑ is hydrogen for e=0, (R₄)ₑ is R₁R₂R₃N⁺ for e=1, 2, or 3, X is an anion capable of abstracting a proton from the nitrogen of an aniline or aniline derivative, Y is alkyl, aryl, alkyl aryl or benzyl and substituted derivatives thereof, Z is a substituent selected from the group consisting of hydroxyl, halo, and other hetero atoms, where a=the valence of the anionic moiety (1, 2, 3 or 4), b and c are whole number integers of value 1, 2, 3 or 4 and d is a whole number integer of value 0 to 4.

8. The process of claim 7 wherein the amides comprise thioamide and the aliphatic amine comprise aralkyl amine.

9. The process of claim 7 wherein said azo containing compound is represented by the formula
X—R₁—N═N—R₂—Y I
including azoxy or hydrazo derivatives thereof, wherein R₁ is an aromatic group and R₂ is selected from the group consisting of aliphatic and aromatic groups and X and Y are independently selected from the group consisting of hydrogen, halides, —NO₂, —NH₂, aryl groups, alkyl groups, alkoxy groups, sulfonate groups, —SO₃H, —OH, —COH, —COOH, and alkyl, aryl, alkylaryl or benzyl groups, containing at least one —NH₂ group, wherein if R₂ is aliphatic, X is in the meta or ortho position on R₁, and if R₂ is aromatic, at least one of X and Y is on the meta or ortho position on R₁ and R₂ respectively, and wherein halide are selected from the group consisting of fluoride, chloride, and bromide.

10. The process of claim 1 wherein when both R₁ and R₂ of formula I are aromatic and both para positions are unsubstituted, then both R₁ and R₂ are available to be substituted by the nucleophilic compound in step (b) to produce diamido or diamino substituted aromatic azo and/or hydrazo compounds.

11. A process for directly producing amino substituted aromatic azo compounds, or hydrazo compounds, or aminoaromatic amines, or mixtures thereof by reacting a urea or an amide with an azo containing compound.

12. A process for preparing amino substituted aromatic azo and hydrazo compounds or substituted derivatives thereof, comprising reacting amido substituted aromatic azo and/or hydrazo compounds, prepared by reacting an amide with an azo containing compound in accordance with claim 1 with a nucleophile to produce the corresponding amide and the amino substituted aromatic azo and hydrazo compounds.

13. A process according to claim 12, wherein the nucleophile is ammonia or aniline.

14. The process of claim 12 wherein the amido substituted aromatic azo and/or hydrazo compounds are reacted with water in the presence of a suitable basic or acidic catalyst to produce the acid or salt thereof corresponding to the amide starting material and the amino substituted aromatic azo and/or hydrazo compound.

15. A process for preparing aminoaromatic amides or substituted derivatives thereof comprising reducing the amido substituted aromatic azo and/or hydrazo compounds, prepared in accordance with claim 1 alone or in mixtures with aminoaromatic amides.

16. A process for preparing alkylamino aromatic amides that comprises reductively alkylating the aminoaromatic amides, or the amido substituted aromatic azo and/or hydrazo compounds, or mixtures thereof that are prepared according to claim 1.

17. A process for preparing aminoaromatic amines or substituted derivatives thereof comprising reacting the aminoaromatic amide or substituted derivatives thereof prepared in accordance claim 1 with a nucleophile or water to produce the respective amide, or the acid or salt thereof corresponding to the amide starting material, and the aminoaromatic amine.

18. A process for preparing aminoaromatic amines or substituted derivatives thereof, comprising reducing the amino substituted aromatic azo and/or hydrazo compounds, alone or in mixtures with aminoaromatic amines, which are prepared according to claim 1.

19. A process for preparing monoalkyl aromatic diamines or substituted derivatives thereof, comprising reducing the alkylamino substituted or di(alkylamino) substituted azo and/or hydrazo compounds or substituted derivatives thereof, prepared by the reaction of an aliphatic amine or substituted derivatives thereof with an azo compound or substituted derivatives thereof in accordance with claim 1.

20. A process for preparing arylamino aromatic diamines or substituted derivatives thereof, comprising reducing the arylamino substituted or di(arylamino) substituted azo and/or hydrazo compounds or substituted derivatives thereof, prepared by the reaction of an aromatic amine or substituted derivatives thereof with an azo compound or substituted derivatives thereof in accordance with claim 1.

21. A process is provided for preparing alkylated and dialkylated phenylenediamines or substituted derivatives thereof, which comprises reductively alkylating the amino substituted aromatic azo and/or hydrazo compounds, or aminoaromatic amines, or mixtures thereof that are prepared in accordance with claim 1.

22. A process for preparing dialkylated aromatic diamines comprising reductively alkylating monoalkyl aromatic diamines prepared in accordance with claim 1.

23. A process for preparing alkylated arylamino aromatic diamines comprising reductively alkylating arylamino aromatic diamines prepared in accordance with claim 1.

24. A process for preparing dialkylated aromatic diamines comprising reductively alkylating monoalkyl aromatic diamines prepared in accordance with claim 19.

25. A process for preparing alkylated arylamino aromatic diamines comprising reductively alkylating arylamino aromatic diamines prepared in accordance with claim 20.

26. A process for preparing 4-aminodiphenylamine, comprising reducing the phenylamino substituted aromatic azo and/or hydrazo compounds, alone or in mixtures with 4-aminodiphenylamines, which are prepared according to claim 1, wherein the azo containing compound is azobenzene and the nucleophilic compound is aniline, formanilide, phenylurea, carbanilide, thiocarbanilide, or mixtures thereof.

27. A process for preparing p-phenylenediamine, comprising reducing the amino substituted aromatic azo and/or hydrazo compounds, alone or in mixtures with p-phenylenediamine, which are prepared according to claim 1, wherein the azo containing compound is azobenzene and the nucleophilic compound is urea.

28. A process for preparing aminoaromatic amines, alkylamino aromatic diamines or arylamino aromatic diamines, or substituted derivatives thereof, comprising reducing, in the presence of water and an acidic or basic catalyst, the amido substituted aromatic azo and/or hydrazo compounds, alone or in mixtures with the corresponding aminoaromatic amines, which are prepared according to claim 1, to produce the amine compound and the acid or salt thereof corresponding to the starting amide.

29. A process for preparing aminoaromatic amines, alkylamino aromatic diamines or arylamino aromatic diamines, or substituted derivatives thereof, comprising reducing, in the presence of a nucleophile, the amido substituted aromatic azo and/or hydrazo compounds, alone or in mixtures with the corresponding/aminoaromatic amines, which are prepared according to claim 1, to produce the amine compound and the corresponding amide.

30. A process according to claim 29, wherein the nucleophile is ammonia or aniline.

31. A process for preparing amino substituted aromatic azo and hydrazo compounds or substituted derivatives thereof, comprising reacting amido substituted aromatic azo and/or hydrazo compounds, prepared by reacting an amide with an azo containing compound in accordance with claim 4 with a nucleophile to produce the corresponding amide and the amino substituted aromatic azo and hydrazo compounds.

32. The process of claim 31, wherein the nucleophile is ammonia or aniline.

33. The process of claim 31 wherein the amido substituted aromatic azo and/or hydrazo compounds are reacted with water in the presence of a suitable basic or acidic catalyst to produce the acid or salt thereof corresponding to the amide starting material and the amino substituted aromatic azo and/or hydrazo compound.

34. A process for preparing aminoaromatic amides or substituted derivatives thereof comprising reducing the amido substituted aromatic azo and/or hydrazo compounds, prepared in accordance with claim 4 alone or in mixtures with aminoaromatic amides.

35. A process for preparing alkylamino aromatic amides that comprises reductively alkylating the aminoaromatic amides, or the amido substituted aromatic azo and/or hydrazo compounds, or mixtures thereof that are prepared according to claim 4.

36. A process for preparing aminoaromatic amines or substituted derivatives thereof comprising reacting the aminoaromatic amide or substituted derivatives thereof prepared in accordance claim 4 with a nucleophile or water to produce the respective amide, or the acid or salt thereof corresponding to the amide starting material, and the aminoaromatic amine.

37. A process for preparing aminoaromatic amines or substituted derivatives thereof, comprising reducing the amino substituted aromatic azo and/or hydrazo compounds, alone or in mixtures with aminoaromatic amines, which are prepared according to claim 4.

38. A process for preparing monoalkyl aromatic diamines or substituted derivatives thereof, comprising reducing the alkylamino substituted or di(alkylamino) substituted azo and/or hydrazo compounds or substituted derivatives thereof, prepared by the reaction of an aliphatic amine or substituted derivatives thereof with an azo compound or substituted derivatives thereof in accordance with claim 4.

39. A process for preparing arylamino aromatic diamines or substituted derivatives thereof, comprising reducing the arylamino substituted or di(arylamino) substituted azo and/or hydrazo compounds or substituted derivatives thereof, prepared by the reaction of an aromatic amine or substituted derivatives thereof with an azo compound or substituted derivatives thereof in accordance with claim 4.

40. A process is provided for preparing alkylated and dialkylated phenylenediamines or substituted derivatives thereof, which comprises reductively alkylating the amino substituted aromatic azo and/or hydrazo compounds, or aminoaromatic amines, or mixtures thereof that are prepared in accordance with claim 4.

41. A process for preparing dialkylated aromatic diamines comprising reductively alkylating monoalkyl aromatic diamines prepared in accordance with claim 4.

42. A process for preparing alkylated arylamino aromatic diamines comprising reductively alkylating arylamino aromatic diamines prepared in accordance with claim 4.

43. A process for preparing dialkylated aromatic diamines comprising reductively alkylating monoalkyl aromatic diamines prepared in accordance with claim 38.

44. A process for preparing alkylated arylamino aromatic diamines comprising reductively alkylating arylamino aromatic diamines prepared in accordance with claim 39.

45. A process for preparing 4-aminodiphenylamine, comprising reducing the phenylamino substituted aromatic azo and/or hydrazo compounds, alone or in mixtures with 4-aminodiphenylamines, which are prepared according to claim 4, wherein the azo containing compound is azobenzene and the nucleophilic compound is aniline, formanilide, phenylurea, carbanilide, thiocarbanilide, or mixtures thereof.

46. A process for preparing p-phenylenediamine, comprising reducing the amino substituted aromatic azo and/or hydrazo compounds, alone or in mixtures with p-phenylenediamine, which are prepared according to claim 4 wherein the azo containing compound is azobenzene and the nucleophilic compound is urea.

47. A process for preparing aminoaromatic amines, alkylamino aromatic diamines or arylamino aromatic diamines, or substituted derivatives thereof, comprising reducing, in the presence of water and an acidic or basic catalyst, the amido substituted aromatic azo and/or hydrazo compounds, alone or in mixtures with the corresponding aminoaromatic amines, which are prepared according to claim 4 to produce the amine compound and the acid or salt thereof corresponding to the starting amide.

48. A process for preparing aminoaromatic amines, alkylamino aromatic diamines or arylamino aromatic diamines, or substituted derivatives thereof, comprising reducing, in the presence of a nucleophile, the amido substituted aromatic azo and/or hydrazo compounds, alone or in mixtures with the corresponding aminoaromatic amines, which are prepared according to claim 4 to produce the amine compound and the corresponding amide.

49. A process according to claim 48, wherein the nucleophile is ammonia.

50. A process for preparing amino substituted aromatic azo and hydrazo compounds or substituted derivatives thereof, comprising reacting amido substituted aromatic azo and/or hydrazo compounds, prepared by reacting an amide with an azo containing compound in accordance with claim 7 with a nucleophile to produce the corresponding amide and the amino substituted aromatic azo and hydrazo compounds.

51. A process according to claim 50, wherein the nucleophile is ammonia or aniline.

52. The process of claim 50 wherein the amido substituted aromatic azo and/or hydrazo compounds are reacted with water in the presence of a suitable basic or acidic catalyst to produce the acid or salt thereof corresponding to the amide starting material and the amino substituted aromatic azo and/or hydrazo compound.

53. A process for preparing aminoaromatic amides or substituted derivatives thereof comprising reducing the amido substituted aromatic azo and/or hydrazo compounds, prepared in accordance with claim 7 alone or in mixtures with aminoaromatic amides.

54. A process for preparing alkylamino aromatic amides that comprises reductively alkylating the aminoaromatic amides, or the amido substituted aromatic azo and/or hydrazo compounds, or mixtures thereof that are prepared according to claim 7.

55. A process for preparing aminoaromatic amines or substituted derivatives thereof comprising reacting the aminoaromatic amide or substituted derivatives thereof prepared in accordance claim 7 with a nucleophile or water to produce the respective amide, or the acid or salt thereof corresponding to the amide starting material, and the aminoaromatic amine.

56. A process for preparing aminoaromatic amines or substituted derivatives thereof, comprising reducing the amino substituted aromatic azo and/or hydrazo compounds, alone or in mixtures with aminoaromatic amines, which are prepared according to claim 7.

57. A process for preparing monoalkyl aromatic diamines or substituted derivatives thereof, comprising reducing the alkylamino substituted or di(alkylamino) substituted azo and/or hydrazo compounds or substituted derivatives thereof, prepared by the reaction of an aliphatic amine or substituted derivatives thereof with an azo compound or substituted derivatives thereof in accordance with claim 7.

58. A process for preparing arylamino aromatic diamines or substituted derivatives thereof, comprising reducing the arylamino substituted or di(arylamino) substituted azo and/or hydrazo compounds or substituted derivatives thereof, prepared by the reaction of an aromatic amine or substituted derivatives thereof with an azo compound or substituted derivatives thereof in accordance with claim 7.

59. A process is provided for preparing alkylated and dialkylated phenylenediamines or substituted derivatives thereof, which comprises reductively alkylating the amino substituted aromatic azo and/or hydrazo compounds, or aminoaromatic amines, or mixtures thereof that are prepared in accordance with claim 7.

60. A process for preparing dialkylated aromatic diamines comprising reductively alkylating monoalkyl aromatic diamines prepared in accordance with claim 7.

61. A process for preparing alkylated arylamino aromatic diamines comprising reductively alkylating arylamino aromatic diamines prepared in accordance with claim 7.

62. A process for preparing dialkylated aromatic diamines comprising reductively alkylating monoalkyl aromatic diamines prepared in accordance with claim 57.

63. A process for preparing alkylated arylamino aromatic diamines comprising reductively alkylating arylamino aromatic diamines prepared in accordance with claim 58.

64. A process for preparing 4-aminodiphenylamine, comprising reducing the phenylamino substituted aromatic azo and/or hydrazo compounds, alone or in mixtures with 4-aminodiphenylamines, which are prepared according to claim 7 wherein the azo containing compound is azobenzene and the nucleophilic compound is aniline, formanilide, phenylurea, carbanilide, thiocarbanilide, or mixtures thereof.

65. A process for preparing p-phenylenediamine, comprising reducing the amino substituted aromatic azo and/or hydrazo compounds, alone or in mixtures with p-phenylenediamine, which are prepared according to claim 7 wherein the azo containing compound is azobenzene and the nucleophilic compound is urea.

66. A process for preparing aminoaromatic amines, alkylamino aromatic diamines or arylamino aromatic diamines, or substituted derivatives thereof, comprising reducing, in the presence of water and an acidic or basic catalyst, the amido substituted aromatic azo and/or hydrazo compounds, alone or in mixtures with the corresponding aminoaromatic amines, which are prepared according to claim 7 to produce the amine compound and the acid or salt thereof corresponding to the starting amide.

67. A process for preparing aminoaromatic amines, alkylamino aromatic diamines or arylamino aromatic diamines, or substituted derivatives thereof, comprising reducing, in the presence of a nucleophile, the amido substituted aromatic azo and/or hydrazo compounds, alone or in mixtures with the corresponding aminoaromatic amines, which are prepared according to claim 7 to produce the amine compound and the corresponding amide.

68. A process according to claim 67, wherein the nucleophile is ammonia or aniline.

69. The process of claim 4 wherein when both R₁ and R₂ of formula I are aromatic and both para positions are unsubstituted, then both R₁ and R₂ are available to be substituted by the nucleophilic compound in step (b) to produce diamido or diamino substituted aromatic azo and/or hydrazo compounds.

70. The process of claim 7 wherein when both R₁ and R₂ of formula I are aromatic and both para positions are unsubstituted, then both R₁ and R₂ are available to be substituted by the nucleophilic compound in step (b) to produce diamido or diamino substituted aromatic azo and/or hydrazo compounds.

71. The process of claim 1 wherein the reactive contact is carried out at a temperature of from about 20° C. to about 150° C. and a pressure of from about 20 mbar to about 20 barg.

72. The process of claim 4 wherein the reactive contact is carried out at a temperature of from about 20° C. to about 150° C. and a pressure of from about 20 mbar to about 20 barg.

73. The process of claim 7 wherein the reactive contact is carried out at a temperature of from about 20° C. to about 150° C. and a pressure of from about 20 mbar to about 20 barg.

74 A process for the reductive alkylation of amido azo, amido hydrazo, or amidoamine compounds concurrent with the hydrolysis of amide groups to amine groups, which are also reductively alkylated, comprising reducing said amido azo, amido hydrazo, or amidoamine compounds in the presence of water and a suitable basic or acidic catalyst at conditions that do not reduce the amide carbonyl groups, to produce the alkylated aryl amine and/or dialkylated diamine and the acid or salt thereof corresponding to the starting amide.
